(19) United States
(12) Patent Application Publication
(10) Pub. No.: US 2013/0085797 A1
(43) Pub. Date: Apr. 4, 2013

(54) PROMISE DRIVEN PLANNING IN A SUPPLY CHAIN

(71) Applicant: FABRICE LAUR, Heidelberg (DE)

(72) Inventor: FABRICE LAUR, Heidelberg (DE)

(21) Appl. No.: 13/252,224

(22) Filed: Oct. 4, 2011

(51) Int. Cl. G06Q 10/04

(52) U.S. Cl. 705/7.21; 705/7.18

(57) ABSTRACT

Various embodiments of systems and methods for a promise driven planning are described herein. Customer requests are received for a product, which includes the requested quantity of the product and the requested date for delivering the product. A promise date for delivering the product is determined based on the material plan of the product. The requested quantity of the product is summed to obtain a cumulative demand of the product. The cumulative demand of the product is compared with the cumulative material plan of the product. Based on the comparison, the delivery of the product is planned either based on the promise date or the requested date.

### FIELD

Embodiments generally relate to computer systems, and more particularly to methods and systems for planning in a supply chain.

### BACKGROUND

Planning systems, such as Enterprise Resource Planning (ERP), Material Requirements Planning (MRP) and Advanced Planning and Scheduling (APS) are well known in many industries today as useful tools for planning enterprise operations. ERP systems provide a framework that integrates many facets of a business, including planning, manufacturing, supply chain management, sales and marketing. Supply chain management includes planning supply of goods to customer based on the requested delivery date of customer.

Smaller companies often outsource production to others. For these companies, it is often hard to foresee which of its products would be successful. Therefore, the sales forecast by these companies tends to be inaccurate. Forecast inaccuracy and outsourcing production creates an inflexible supply chain with long reaction times.

In the event any of these branded products are successful, the customer demand for such product can sky rocket and requested lead times for the delivery for the products become short. Small companies fail to procure the product in order to meet such immediate demands. This leads to a short-term wave of high demand for the product that disrupts the supply planning process.

### SUMMARY

Various embodiments of systems and methods for promise driven planning in a supply chain are described herein.

In one aspect, customer requests are received for a product, which includes a requested quantity of the product and a requested date for receiving the product.

In another aspect, a promise date is determined for delivering the product based on a material plan of the product.

In another aspect, the requested quantity of the product is summed to obtain a cumulative demand of the product.

In another aspect, the cumulative demand of the product is compared with a cumulative material plan of the product.

In still another aspect, the product is planned to be delivered to the customer based on the promise date and the requested date.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram illustrating a method for planning delivery of a product in a supply chain, according to an embodiment.

FIG. 2 is a flow diagram illustrating a method for determining a material plan of a product, according to an embodiment.

FIG. 3 is a detailed flow diagram illustrating a method for planning delivery of the product in the supply chain, according to an embodiment.

FIG. 4 is an exemplary planning table including information for planning delivery of a product, according to an embodiment.

FIG. 5 is a quantity-time graph illustrating time based patterns of the material plan and the promised quantity illustrated in FIG. 4, respectively, according to an embodiment.

FIG. 6 is a graph illustrating patterns for the promised alert and the requested alert of FIG. 4, respectively, according to an embodiment.

FIG. 7 illustrates a user interface displaying an exemplary sales order of a product, according to an embodiment.

FIG. 8 is a block diagram illustrating a computing environment in which the techniques described for promise driven planning in a supply chain, according to an embodiment.

### DETAILED DESCRIPTION

Embodiments of techniques for promise driven planning in a supply chain are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

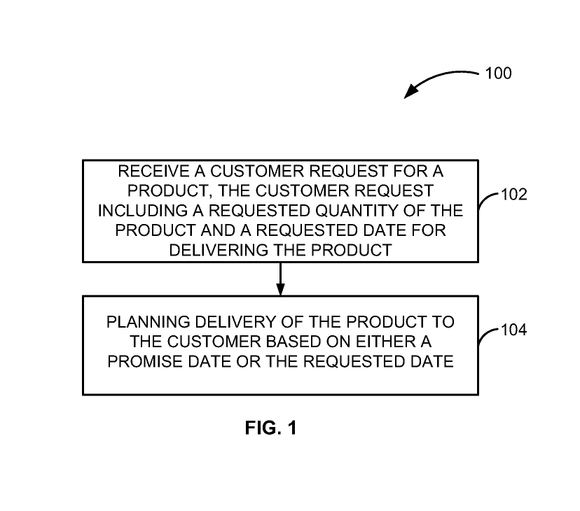

FIG. 1 is a flow diagram 100 illustrating a method for planning delivery of a product in a supply chain, according to an embodiment. Initially at block 102 a customer's request is received for a product. The customer request for the product includes a requested quantity of the product and a requested date for delivering the product to the customer. For example, a customer request may be to deliver 200 pairs (requested quantity) of shoes (product) by Dec. 31, 2011 (requested date).

Next at block 104, a planning is done to deliver the requested quantity of product to the customer. Usually, the planning is done based on the requested date, to ensure that the product is delivered to the customer on the date requested by the customer. For example, in case the production of the product is outsourced to an external manufacturer, the planning is done to ensure that the product is received in the warehouse of the company, from the external manufacturer, before the requested date.

In one embodiment, the planning is done based on a promise date instead of the requested date. For example, in case of a high demand product it might be tough for a planner to plan the delivery of the product by the requested date. In this case the planner may switch the planning of the product to be based on the promise date instead of the requested date. The promise date is determined based on a material plan of the product. The material plan includes supply information of the product. For example, the supply information may include details about when the company expects to receive the product from the external manufacturer. As the promise date is based on the material plan (e.g., supply information) of the product it will allow the planner to relax the constraints on the supply chain.

In the above example, the material plan for shoes may include supply information that 200 pieces of the shoes will be received from an external manufacturer by Jan. 31, 2012. Based on the material plan, the promise date may be determined as Jan. 31, 2012. The supply chain planning for delivering 200 shoes may then be done based on Jan. 31, 2012 (promise date) instead of Dec. 31, 2011 (requested date). A planner may choose between the requested date and the promise date for the supply chain planning.

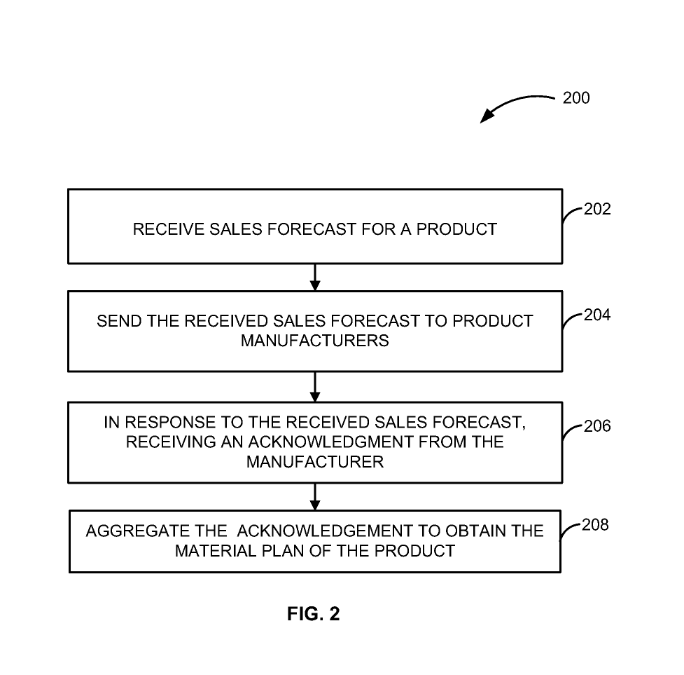

FIG. 2 is a flow diagram 200 illustrating a method for determining the material plan of a product, according to an embodiment. Initially at block 202, a sales forecast of the product is received. The sales forecast may be received by a planning system that is used to plan the delivery of the product. The sales forecast may be received from companies selling the product or even large customers of the product based on their market knowledge. The sales forecast is a forecast about the market demand of the product in the future. The sales forecast may include the projected sales (quantity of the product that the company expects to sell) of the product on a time based manner (for example weekly, monthly, or yearly). In the above example, the sales forecast from a company X selling shoes may include information that company X expects sale (projected sales) of 100 pieces of shoes in January, 200 pieces of shoes in February, 600 pieces of shoes in March, etc.

Next, the planning system sends the sales forecast received in block 202 to product manufacturers that manufacture the product (block 204). The product manufacturer in response sends an acknowledgment to the planning system (block 206). The acknowledgment includes a times based information (supply information of the product) of when the manufacturer can deliver the quantity of product in the sales forecast. In the above example, a manufacturer XYZ of shoes, may in response to a received sales forecast of 100 pieces in January, provide an acknowledgment that the manufacturer XYZ can deliver 80 pieces of the shoes in January (and not 100 as in the sales forecast), and the remaining 20 pieces in March. The acknowledgment from the manufacturers may be received as a daily update from the manufacturer. The acknowledgment can be received in form of an E-Mail or a PDF file. The received acknowledgment is stored in the planning system.

Finally, the acknowledgment received at block 206 is aggregated by the planning system to obtain the material plan of the product (block 208). As discussed above, the acknowledgment includes time based supply information of the product based on the sales forecast. Therefore, the material plan includes a time based aggregated supply information for the product based on the sales forecast. For example, if the total expected sales of a product Z in 2012 is 5 pieces (2 pieces in January, 1 piece in February, and 2 pieces in September) then the material plan for product Z includes information (supply information) of when these 5 pieces will be delivered (for example the material plan may include supply information (acknowledgment) that 1 piece of the product can be delivered in January, 2 pieces of the product can be delivered in March, and 2 pieces of the product can be delivered in September).

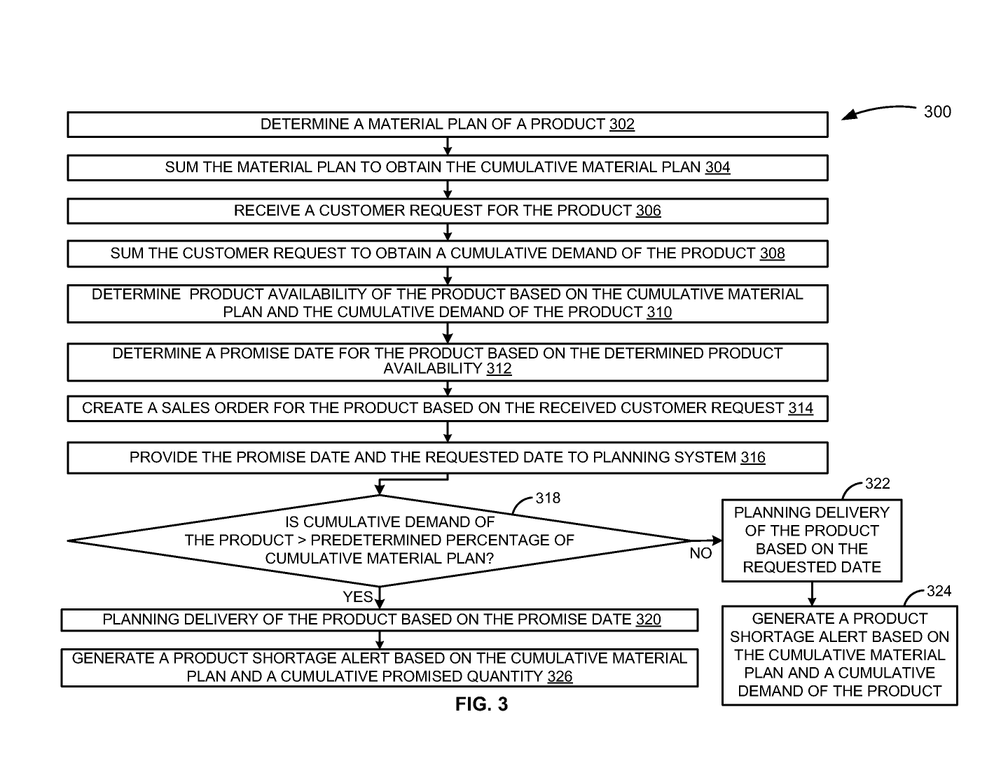

FIG. 3 is a detailed flow diagram 300 illustrating a method for planning delivery of the product in the supply chain, according to an embodiment. Initially at block 302, the material plan of the product is determined. As discussed above in FIG. 2, the material plan (supply information) of the product is determined by aggregating the acknowledgment received from product manufacturers. Next at block 304, the determined material plan is summed on a time based manner to obtain the cumulative material plan of the product. For example, if the material plan of the product in first week of January is 3 and in the second week of January is 5 then the cumulative material plan in the first week of January is 3 and the cumulative material plan for the second week of January is 8 (sum of the material plan of the first week (3) and the second week (5)).

Next at block 306 a customer request is received for the product. The customer request may be received from a plurality of customers. As discussed above, the customer request includes a requested quantity of the product and a requested date for delivering the product. The requested quantity of the product, in the customer request received at block 306, is summed on a time based manner to obtain the cumulative demand of the product (block 308). For example, if the requested quantity of a product in first week of January is 30 and in second week of January 40 then the cumulative demand of the product in the first week of January is 30 and in the second week of January is 70 (sum of requested quantity in the first week (40) and the second week of January (30)).

Next at block 310 a product availability of the product is determined by the planning system based on the cumulative material plan of the product obtained at block 304 and the cumulative demand of the product obtained at block 308. The product availability of the product is determined by the planning system on a time based manner. For example, the product availability of the product can be determined on a weekly basis, monthly basis, yearly basis, etc. In one embodiment, the product availability of a product is a difference between the cumulative material plan of the product, obtained at block 304, and the cumulative demand of the product, obtained at block 308, for the same period of time. For example, if the cumulative material plan of the product for the second week of January is 25 and the cumulative demand of the product for the second week of January is 10 then the product availability of the product for the second week of January is 15 (difference between the cumulative material plan (25) and the cumulative demand (10) of the product in the second week of January).

Next, a promise date of the product is determined by the planning system based on the product availability determined at block 310 (block 312). Based on the product availability, the planning system may provide the earliest date when the product will be available for delivery, as the promise date for delivering the product. For example, if a customer requests for 30 pieces of a product to be delivered by the 30^{th} of June, the planning system based on the product availability determines that the earliest date when 30 pieces are available for delivery is 30^{th} August. In this case, the promise date provided by the planning system for delivery of 30 pieces may be 30^{th} August. The planning system may also provide a promised quantity of the product that will be delivered by the promised date based on the product availability.

In one embodiment, the promise date is determined by a planner based on their knowledge of supply information. For example, if a company in US is outsourcing manufacturing of a product to China. A planner of the company in US might be aware about when the goods from the manufacturer in China will be reaching US (supply information). Based on this knowledge about the supply information, the planner of the company in US may provide the promise date to the planning system.

In another embodiment, the promise date is determined based on a predetermined rule. For example, a predetermined rule may be that for the month of August the promise date cannot be before 3 weeks from the date of receiving customer request. In this case if a customer request for a product is received on 1 Aug. 2011 the promise date may be determined as 21 Aug. 2011 (3 weeks from the date of request).

Next a sales order is created for the product based on the customer requested received in block 306 (block 314). The sales order includes a plurality of items related to the sales of the product. For example, the plurality of items in the sales order includes a requested quantity of the product, a requested date for delivering the product, a promise date, etc. Based on the customer request received at block 306 and the promise date determined at block 312, a sales representative may enter this information in the sales order. The sales representative enters both the promise date and the requested date in the sales order of the product. In one embodiment, the sales representative enters the promise date after the customer approves the promise date. The planning system may provide the product availability of the product determined at block 310 to the sales representative. Based on the product availability of the product, the sales representative enters the promise date in the sales order of the product.

Next, the promise date and the requested date entered in the sales order is provided to the planning system (block 316). The planning system then determines whether delivery of the product is to be planned based on the promise date or the requested date. In one embodiment, the determination is made by comparing the cumulative demand of the product with the cumulative material plan of the product (block 318). If the cumulative demand of the product is greater than a predetermined percentage of the cumulative material plan, of the product, for a same period of time, then the planning system plans delivery of the product based on the promise date (block 320). In case the condition in block 318 is false the supply planning plans delivery of the product based on the requested date (block 322). For example, if the cumulative demand is 120% (predetermined percentage) of the cumulative supply for the first 3 months of the year, the planning system plans delivery of the product based on the promise date.

In one embodiment, the decision to switch between the promise date and the requested date for planning delivery of the product is decided by a planner. When the cumulative demand of the product is greater than the predetermined percentage of the material plan a recommendation is sent to the planner, to switch from the requested date to the planning date, by raising a planning exception. In the above example, an exception may be raised “Too much demand in the first 3 months, change planning-relevant date to promise date.” A work task, instructing the planner to switch from the request date to the promise date, may also be created for the planner when the cumulative demand is greater than the predetermined percentage of the material plan.

The planner may also consider several other factors to determine whether the planning is to be done based on the promise date or the requested date. For example, for a high priority customer the planner always chooses the requested date (delivery date requested by the high priority customer) for planning delivery. Similarly, in case a penalty is involved for late delivery the planner may always choose the requested date for planning delivery of the product.

The decision between the promise date and the requested date for planning delivery of the product is done on a product basis. For example, if a planner decides that for a product Z the planning is to be done based on requested date then for all customer requests for product Z the planning will be done based on the requested date.

In case the planning is to be done based on the requested date, a product shortage alert is generated by the planning system when the cumulative demand of the product (obtained in block 308) is greater than the cumulative material plan (obtained in block 304), for the same period of time (block 324). In case the planning is to be done based on the promise date, a product shortage alert is generated based on the difference between the cumulative material plan (obtained in block 308) of the product and a cumulative promised quantity (promised quantity summed on a time based manner), for the same period of time (block 326).

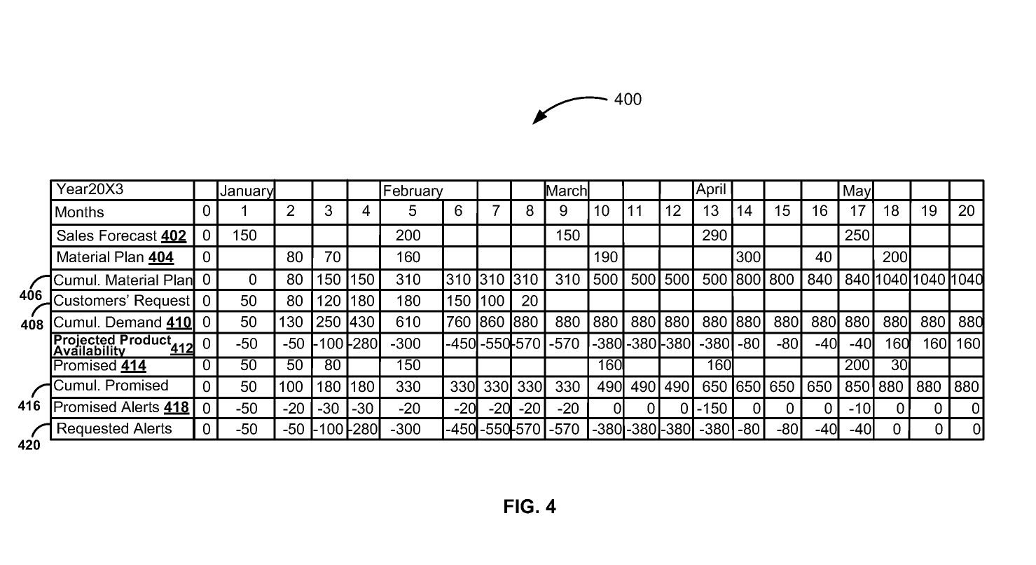

FIG. 4 is an exemplary planning table 400 including information for planning delivery of a product, according to an embodiment. The planning table 400 includes a sales forecast 402 that includes projected sales of the product on a weekly basis. The sales forecast 402 is received from a company selling the product based on the quantity of the product the company expects to sell from January to May. As shown in the sales forecast 402 the company expects to sell 150 pieces of the product in the first week (January), 200 pieces of the product by the fifth week (February), 150 pieces in the ninth week (March), 290 pieces in the thirteenth week (April), and 250 pieces in the seventeenth week (May).

The sales forecast 402 for the product is provided to a manufacturer of the product. In response to the sales forecast 402 the manufacturer provides acknowledgment, which includes information about the quantity of the product the manufacturer can deliver on a weekly basis. The acknowledgment received from the manufacturer is aggregated in the material plan 404. As shown in the material plan 404, the manufacturers cannot supply 150 pieces of the product in the first week as required by the sales forecast. The manufacturer can only supply 80 pieces of the product in the second week (January), another 70 pieces of the product in the third week (January). Based on the sales forecast 402 of 200 pieces in the fifth week (February) the manufacturer can supply only 160 pieces in the fifth week (February). Next, based on the sales forecast 402 of 150 pieces in the ninth week, according to the customer acknowledgment the supplier cannot supply any product in the ninth week. However, as shown in the material plan 404 the manufacturer can supply 190 pieces in the tenth week (March). Similarly, the material plan 404 includes supply information for weeks 11-20 based on the sales forecast 402.

The quantity of the product in the material plan is summed on a weekly basis to obtain the cumulative material plan 406 of the product. As shown, the cumulative material plan 406 of the product is 80 for the second week (January), 150 for the third week (January) (sum of the material plan for the first three weeks), 310 for the fifth week (February) (sum of the material plan of the first five weeks), 500 for the tenth week (March). Similarly the cumulative material plan 406 for the remaining weeks (11-20) is determined.

Next the customers' request 408 for the product is received from the customer. The customers' request 408 includes the requested quantity of the product and the requested date for delivering the product. As shown in the customers' request 408 row, the customers have requested for 50 pieces (requested quantity) of the product in the first week (January) (requested date), 80 pieces of the product in the second week (January), 120 pieces in the third week (January), 180 pieces of the product in the fourth week (January), 180 pieces of the product in the fifth week (February), 150 pieces of the product in the sixth week (February), 100 pieces of the product in the seventh week (February), and 20 pieces of the product in the eighth week (February).

The customers' request 408 is then summed on a time based manner to obtain the cumulative demand 410 of the product. As shown, the cumulative demand 410 of the product is 50 pieces in the first week, 130 pieces in the second week (sum of the customer request for the first week (50) and the second week (80)), 250 pieces for the third week (sum of the customer request for the first week (50), the second week (80) and the third week (120)). Similarly the cumulative demand 410 is determined for the remaining weeks (weeks 4-20).

Next, projected product availability 412 of the product is determined The projected product availability 412 of the product is determined based on the material plan 404 (supply information) of the product. The difference between the cumulative material plan 406 and the cumulative demand 410 of the product is determined as the product availability 412 of the product. As shown, the projected product availability 412 of the product for the first week is −50 (difference between the cumulative material plan 406 (0) and the cumulative demand 410 (50) for the first week), the projected product availability 412 of the product is −50 for the second week (difference between the cumulative material plan 406 (80) and the cumulative demand 410 (130) for the second week). Similarly, the cumulative demand 410 is determined for the remaining weeks (weeks 3-20).

Next, a promise date “promised” 414 of the product is determined by the planning system for planning delivery of the product. The planning system determines the promise date based on the projected product availability 412 of the product. The planning system also determines a promised quantity of the product to be delivered by the promise date based on the requested quantity of the product in the customer request 408. As shown, for a customer request 408 of 50 pieces of the product in the first week 50 pieces are promised to be delivered to the customers by the first week (promise date 414), for a customers' request 408 of 80 pieces in the second week only 50 pieces are promised to be delivered by the second week (promise date 414), for a customers' request 408 of 120 pieces in the third week only 80 pieces are promised to be delivered to the customers in the third week (promise date 414), for a customers' request 408 of 180 pieces in the fourth week 0 pieces are promised to be delivered in the fourth week (promise date 414) as there is no product supply (material plan (404) 0 in the fourth week. Similarly, the promise date and a promised quantity for the product are determined for the remaining 16 weeks (week 5-20). When the planning system plans delivery of the product based on the promise date 414 instead of the requested date (in the customer request 408), it automatically reduces the discrepancies between the demand of the product (customers' request 408) and the supply of the product (cumulative demand 410 of the product), because the planning system adjust the promise date 414 of the product according to the material plan (supply) 404 of the product.

The quantity of the product “promised” to be delivered on the promise date 414 are summed on a time based manner to obtain the “cumulative promised” quantity 416 of the product. As shown, the “cumulative promised” quantity 416 of the product for the first week (January) is 50, for the second week is 100 (sum of the “promised” quantity in the first week (50) and “promised” quantity in the second week (50)), for the third week is 180 ((sum of the “promised” quantity in the first week (50) , the “promised” quantity in the second week (50), and the “promised” quantity for the third week (80)). Similarly, the “cumulative promised” quantity 416 is determined for the remaining 17 weeks.

Finally, a promised alert 418 is generated by the planning system, which is indicative of the product shortage (difference between the demand and supply of the product) when the delivery of the product is based on the promised date. In this case, the product shortage is the difference between the cumulative material plan 406 and the cumulative promised quantity 416 of the product on a time based manner. As discussed above, the promised alert 418 is sent to a planner planning the delivery of the product. As shown, the promised alert 418 generated for the first week is −50 (difference between the cumulative material plan 406 of the first week (0) and the cumulative promised quantity 416 (50) for the first week), the promised alert 418 generated for the second week is −20 (difference between the cumulative material plan 406 for the second week (80) and the cumulative promised quantity 416 (100) for the second week). Similarly, the promised alert 418 is determined for the remaining 18 weeks (weeks 3-20). In case the planning is done based on the customer requested date (in the customer request 408), a requested alert 420 is generated by the planning system, which is indicative of the product shortage when the planning is done based on the customer requested date. In this case, the product shortage is the difference between the cumulative material plan 406 of the product and the cumulative demand 410 of the product determined on a time based manner. As shown, the requested alert 420 generated for the first week is −50 (difference between the cumulative material plan 406 for the first week and the cumulative demand 410 (50) for the first week). Similarly, the requested alert 420 is generated for the remaining 19 weeks (week 2-week 20) based on the difference in the cumulative material plan 406 and the cumulative demand 410 for these weeks.

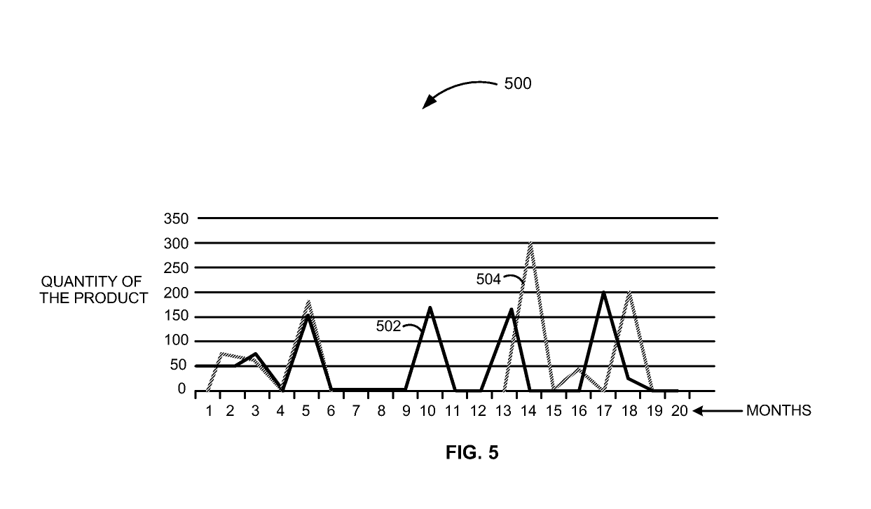

FIG. 5 is a quantity-time graph 500 illustrating time based patterns 502 and 504 of the material plan 404 and the promised quantity 414 illustrated in FIG. 4, respectively, according to an embodiment. As shown, the pattern 502 of the material plan matches with the pattern 504 of the promised quantity because the promise date of the product has been adjusted according to the material plan of the product. This reduces the discrepancy between the product supply and product demand of the product, especially in case of products having short period of high demand. This also reduces the burden on the planner who is planning delivery of the product.

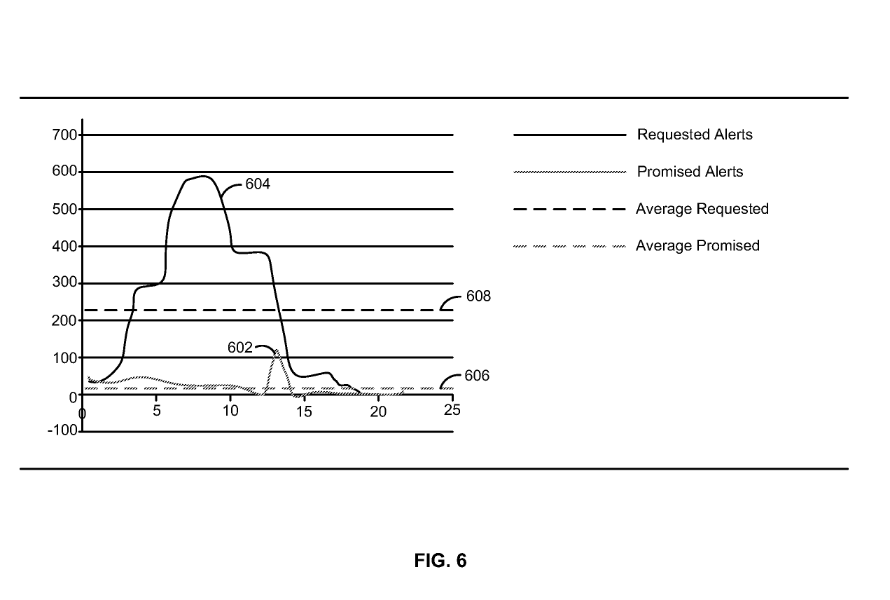

FIG. 6 is a graph illustrating patterns 602 and 604 for the promised alert 418 and requested alert 420 of FIG. 4, respectively, according to an embodiment. The patterns 602 and 604 show the variations in shortage alert when the delivery of the product is planned based on the promise date and the requested alert, respectively. As the promise date is based on the material plan of the product, the pattern 602 of the promised alert is much smoother and stable compared to the pattern 604 of the requested date. The average 606 of the pattern 602 of promised alert is also much smaller compared to the average 608 of the pattern 604 of requested alert. Therefore, in case the planning is done based on the promised date the planner receives lesser product shortage alerts and reduces the burden on the planner.

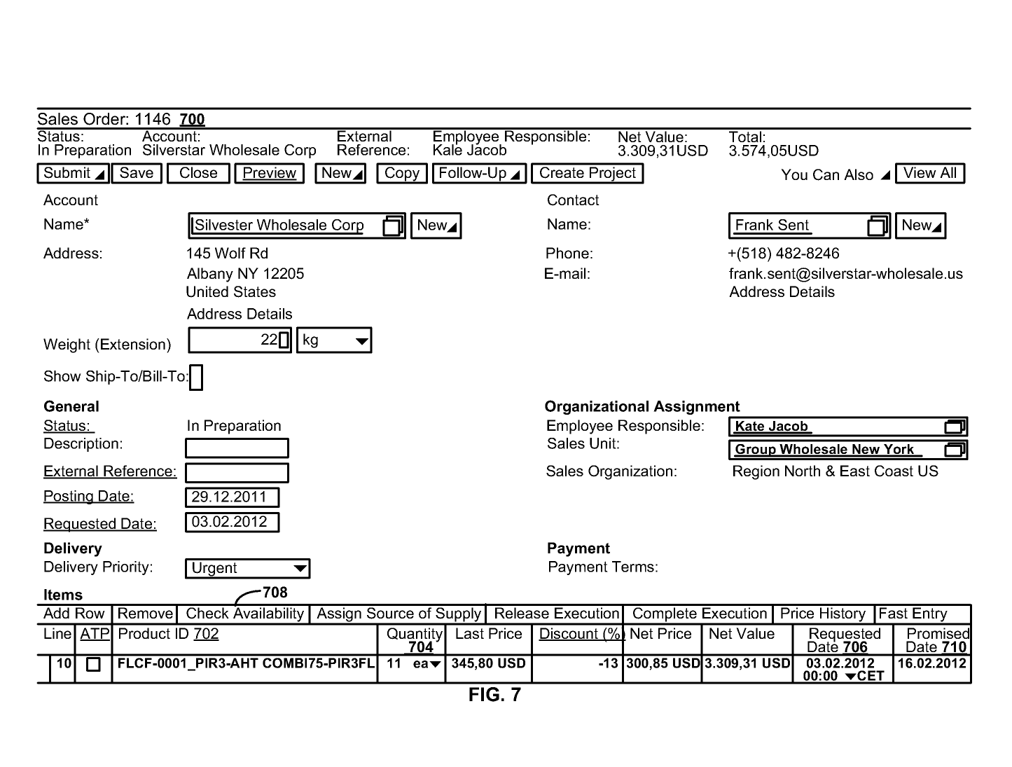

FIG. 7 illustrates a user interface displaying an exemplary sales order 700 of a product, according to an embodiment. A sales representative receives a customer request for delivering 11 pieces of hats of brand “Superior” by Feb. 3, 2012. The sales representative enters the product ID (FLCF-0001_PIR3-AHT COMBI75-PIR3FL) 702 of the hats of brand “Superior”, the quantity 704 (11) of the hats requested, and the requested date 706 Feb. 3, 2012 in the sales order 700 of the hats of brand “X”. In one embodiment, the sales representative then clicks on the “check availability” tab 708 to check product availability of the hats. The planning system provides the product availability information to the sales representative based on the material plan of the hats and the other customers request received for the hats. Based on the product availability of the hats, the sales representative determines a promise date 710 for delivering the hats. After the customer accepts the promise date 710 for receiving the hats the sales representative enters the promise date in the sales order. As shown, in this example the sales representative determines the promise date 710 as Feb. 16, 2012.

Both the promised date 710 and the requested date 704 are then transferred to the planning system, where a decision is made whether the delivery of the product is to be planned based on the requested date 706 or the promised date 710.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

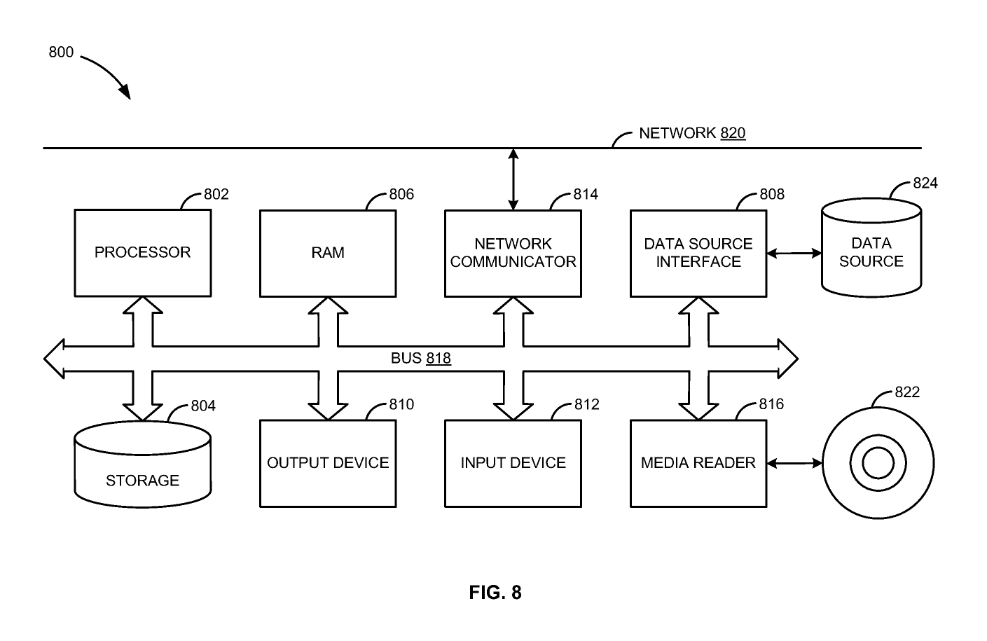

FIG. 8 is a block diagram of an exemplary computer system 800. The computer system 800 includes a processor 802 that executes software instructions or code stored on a computer readable storage medium 822 to perform the above-illustrated methods of the invention. The computer system 800 includes a media reader 816 to read the instructions from the computer readable storage medium 822 and store the instructions in storage 804 or in random access memory (RAM) 806. The storage 804 provides a large space for keeping static data where at least some instructions could be stored for later execution. The stored instructions may be further compiled to generate other representations of the instructions and dynamically stored in the RAM 806. The processor 802 reads instructions from the RAM 806 and performs actions as instructed. According to one embodiment of the invention, the computer system 800 further includes an output device 810 (e.g., a display) to provide at least some of the results of the execution as output including, but not limited to, visual information to users and an input device 812 to provide a user or another device with means for entering data and/or otherwise interact with the computer system 800. Each of these output devices 810 and input devices 812 could be joined by one or more additional peripherals to further expand the capabilities of the computer system 800. A network communicator 814 may be provided to connect the computer system 800 to a network 820 and in turn to other devices connected to the network 820 including other clients, servers, data stores, and interfaces, for instance. The modules of the computer system 800 are interconnected via a bus 818. Computer system 800 includes a data source interface 808 to access data source 824. The data source 824 can be accessed via one or more abstraction layers implemented in hardware or software. For example, the data source 824 may be accessed by network 820. In some embodiments the data source 824 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method for planning delivery of a product in a supply chain, the method comprising:
receiving one or more customer requests for the product, the one or more customer requests including a requested quantity of the product and a requested date for delivering the product;
determining, by a processor of the computer, a promise date for delivering the product based on a material plan of the product;
summing, by the processor of the computer, the requested quantity of the product to obtain a cumulative demand of the product;
comparing, by the processor of the computer, the cumulative demand of the product with a cumulative material plan of the product; and
based on the comparison, planning delivery of the product to the one or more customers, wherein planning delivery of the product is based on the determined promise date and the received requested date.

2. The computer implemented method according to claims 1, wherein planning delivery of the product comprises:
planning delivery of the product based on the determined promise date when the cumulative demand is greater than a predetermined percentage of the cumulative material plan; and
planning delivery of the product based on the requested date when the cumulative demand is less than the predetermined percentage of the cumulative material plan.

3. The computer implemented method according to claim 1, further comprising:
determining the promise date based on a product availability of the product.

4. The computer implemented method according to claim 3, further comprising determining the product availability of the product, wherein determining the product availability comprises:
determining, by the processor of the computer, the material plan of the product;
summing, by the processor of the computer, the material plan of the product to obtain the cumulative material plan; and
determining, by the processor of the computer, the product availability of the product based on the cumulative material plan of the product and the cumulative demand of the product.

5. The computer implemented method according to claim 4, wherein determining the material plan comprises:
receiving a sales forecast of the product;
sending the received sales forecast to a product manufacturer;
based on the sales forecast, receiving an acknowledgment from the product manufacturer, the acknowledgment including information related to product supply; and
aggregating, by the processor of the computer, the received acknowledgment to obtain the material plan of the product.

6. The computer implemented method according to claim 5, wherein determining the promise date comprises:
determining, by the processor of the computer, the promise date based on the received acknowledgment.

7. The computer implemented method according to claim 1, further comprising:
generating, by the processor of the computer, a product shortage alert if the cumulative demand of the product is greater than the cumulative material plan of the product.

8. An article of manufacture including a computer readable storage medium to tangibly store instructions, which when executed by a computer, cause the computer to:
receive one or more customer requests for a product, the one or more customer requests including a requested quantity of the product and a requested date for delivering the product;
determine a promise date for delivering the product based on a material plan of the product;
sum the requested quantity of the product to obtain a cumulative demand of the product;
compare the cumulative demand of the product with a cumulative material plan of the product; and
based on the comparison, planning delivery of the product, wherein planning delivery of the product is based on the determined promise date and the received requested date.

9. The article of manufacturer according to claim 8, further comprising instructions which when executed by the computer further causes the computer to:
plan delivery of the product based on the determined promise date when the cumulative demand is greater than a predetermined percentage of the cumulative material plan; and
plan delivery of the product based on the requested date when the cumulative demand is less than the predetermined percentage of the cumulative material plan.

10. The article of manufacture according to claim 8, further comprising instructions which when executed by the computer further causes the computer to:
determine the promise date based on a product availability of the product.

11. The article of manufacture according to claim 10, further comprising instructions which when executed by the computer further causes the computer to:
determine the material plan of the product;
sum the material plan of the product to obtain the cumulative material plan; and
determine the product availability of the product based on the cumulative material plan of the product and the cumulative demand of the product.

12. The article of manufacture according to claim 11, further comprising instructions which when executed by the computer further causes the computer to:
receive a sales forecast of the product;
send the received sales forecast to a product manufacturer;
based on the sales forecast, receive an acknowledgment from the product manufacturer, the acknowledgment including information related to product supply; and
aggregate the received acknowledgment to obtain the material plan of the product.

13. The article of manufacture according to claim 12, further comprising instructions which when executed by the computer further causes the computer to:
determine the promise date based on the received acknowledgment.

14. The article of manufacture according to claim 8, further comprising instructions which when executed by the computer further causes the computer to:
generate a product shortage alert if the cumulative demand of the product is greater than the cumulative demand of the product is greater than the cumulative material plan of the product.

15. A computer system for planning delivery of a product in a supply chain, the computer system comprising:
a memory to store a program code; and
a processor communicatively coupled to the memory, the processor configured to execute the program code to:
receive one or more customer requests for the product, the one or more customer requests including a requested quantity of the product and a requested date for delivering the product;
determine a promise date for delivering the product based on a material plan of the product;
sum the requested quantity of the product to obtain a cumulative demand of the product;
compare the cumulative demand of the product with a cumulative material plan of the product; and
based on the comparison, planning delivery of the product, wherein planning delivery of the product is based on the determined promise date and the received requested date.

16. The system of claim 15, wherein the processor further executes the program code to:
plan delivery of the product based on the determined promise date when the cumulative demand is greater than a predetermined percentage of the cumulative material plan; and
plan delivery of the product based on the requested date when the cumulative demand is less than the predetermined percentage of the cumulative material plan.

17. The system of claim 15, wherein the processor further executes the program code to:
determine the promise date based on a product availability of the product.

18. The system of claim 17, wherein the processor further executes the program code to:
determine the material plan of the product;
sum the material plan of the product to obtain the cumulative material plan; and
determine the product availability of the product based on the cumulative material plan of the product and the cumulative demand of the product.

19. The system of claim 18, wherein the processor further executes the program code to:
receive a sales forecast of the product;
send the received sales forecast to a product manufacturer;
based on the sales forecast, receive an acknowledgment from the product manufacturer, the acknowledgment including information related to product supply; and
aggregate the received acknowledgment to obtain the material plan of the product.

20. The system of claim 19, wherein the processor further executes the program code to:
determine the promise date based on the received acknowledgment.
